(19) United States
(12) Patent Application Publication
(10) Pub. No.: US 2006/0282460 A1
(43) Pub. Date: Dec. 14, 2006

(54) Method and system for generic data objects

(75) Inventors: Nikhil Pandya, Jaipur (IN); Alok Paul, Bangalore (IN)

Correspondence Address: DRIGGS, HOGG & FRY CO. L.P.A., 38500 CHARDON ROAD, DEPT. IEN, WILLOUGHBY HILLS, OH, 44094, US

(73) Assignee: International Business Machines Corporation, Armonk, NY (US)

(21) Appl. No.: 11/149,476

(22) Filed: Jun. 9, 2005

(51) Int. Cl. G06F 7/00

(52) U.S. Cl. 707/103 R

(57) ABSTRACT

A method and system for defining and handling data objects by mapping a data object to a proxy generic object and handling the generic data object as a proxy for the data object at a server or client side of a network processor transaction. A generic data object class serves as a proxy for each of the data object classes, thereby reducing the classes required on the client side for handling data object properties. In one embodiment, the generic data object class is not preset on the server or client side. In another embodiment, simple data instances are mapped to a first generic data object, complex data instances are converted to a second generic data object and the second generic data object is mapped into the first generic data object.

### FIELD OF THE INVENTION

The present invention is directed toward the field of object-oriented computer environments and, more particularly, toward the processing of data through object-oriented network processing systems.

### BACKGROUND OF THE INVENTION

Data may be defined in terms of “objects” in object-oriented programming. Object-oriented programming may be defined as the use of a class of programming languages and techniques based on the concept of an “object” which is a data structure (abstract data type) encapsulated with a set of routines, called “methods”, which operate on the data. Generally, operations on the data object can only be performed via these methods, which are common to all objects that are instances of a particular “class”. A class is an encapsulated representation of properties and behavior of an object, so an object deals with both the member variables (i.e. the properties of the object) and the member methods (i.e. the behaviors of the objects). Each object has its own values for the variables belonging to its class and can respond to the messages (methods) defined by its class.

It is common in the processing of objects through network processing systems to encounter some specific types of objects that have properties but do not possess any particular behavior and are just an encapsulation to a group of data, commonly designated generically as a “DataObject.”

There are several ways we can distinguish an object of DataObject category:

(1) It does not have any specific behavior. For example, within Java programming architecture and language, “JavaBean” objects or “beans” do not have any behavior except for “getter” and “setter” methods used to access private members.

(2) There is no business behavior associated with the object. For example, a “customer location address” class object may have a method “public void printAddress( )” for customized system use, but this method does not have significance for business logic implementation.

(3) The behavior of the object is not important or relevant to the current system environment. For example, a “Biller” application may receive a first “Account Object” from a “Customer Management” application through a server-to-server communication protocol. Protocol examples include RMI and CORBA/IIOP. However, Customer Management application defined behaviors of the first Account Object will not be relevant to the Biller application. The Biller application will instead use only the data of the first Account Object, and will probably build a second “Account Object” with some behavior specific to its current application.

Similarly, an applet-based UI may retrieve the first Account Object from a server in order to display object information on a display screen. In an applet environment running on a client machine, the business behaviors of the Account Object are of no importance. The Account Object is, therefore, only used to display data to a user.

Some prior art network processing systems and methods process objects thus characterized as DataObjects by defining individual classes for each type of encountered DataObject and then distribute them to clients initially or dynamically. In another prior art approach, DataObject data can actually be transferred in the form of XML text; however, this approach requires complex processing for parsing the XML text and dealing with individual data elements. Moreover, using XML text makes dealing with some simple data types (such as date and time data types) much more complex.

What is needed is a system and method to more efficiently process DataObjects without redefining them as objects at each client, or defining individual classes and/or passing them over the network. What is also needed is a system for simplified data handling without the complex processing and system requirements typical in XML solutions.

### SUMMARY OF THE INVENTION

A method and system for defining and handling data objects by mapping a data object to a proxy generic object and handling the generic data object as a proxy for the data object at a server or client side of a network processor transaction. A generic data object class serves as a proxy for each of the data object classes, thereby reducing the classes required on the client side for handling data object properties. In one embodiment, the generic data object class is not preset on the server or client side. In another embodiment, simple data instances are mapped to a first generic data object, complex data instances are converted to second generic data object and the second generic data object is mapped into the first generic data object.

### BRIEF DESCRIPTION OF THE DRAWINGS

FIG. 1 is a block diagram illustrating data object conversion according to the present invention.

FIG. 2 is a block diagram illustrating data element mapping according to the present invention.

FIG. 3 is a plan view of a computer-readable medium or carrier comprising an embodiment of the present invention tangibly embodied in a computer program residing thereon.

### DESCRIPTION OF THE PREFERRED EMBODIMENTS

The present invention provides a novel “object-oriented” approach wherein a proxy class is designed that maps to all data objects and works as a proxy, rather than having each object at client, and thus requiring the provision of software resources at the client side. The present invention eliminates the need to define individual classes for the data objects and/or pass them over a network. It also provides for simpler data handling, without the complex processing and system requirements of prior art XML solutions. In one aspect of the present invention, a server-defined data structure is provided that may be handled at the server or client side of a network processor transaction without requiring the provision of the individual data object classes to be preset on the client side.

In another aspect of the present invention, by providing a generic class as a proxy for any number of data object classes, a reduced number of classes is required on the client side for data exchanging communications with the server, thus reducing the problem of handling and managing extra classes on the client side. More specifically, a proxy generic data object is provided that can account for any complexity in original data objects by nesting other data objects inside, with all classes on the client side. Typically, in prior art systems in the case of a client using individual data objects from a server, any changes made to the data object classes on the server side must be transmitted to the client so that the client is assured of using the same versions to avoid incompatibility problems. But with the current approach, as the client is not using the individual data object classes but is instead using the generic data object class, the need of maintaining proper versions for the original data object classes is eliminated. In the case of simple data objects, their classes are available on the client side, so there is no need to map simple objects according to the present invention, only complex objects.

The present invention provides a proxy class sufficient to take care of the data needs of all data objects without the need of individual separate classes for each data object. Thus, the invention successfully demonstrates that there is no need to transmit behaviors when only attributes are needed, and that data object attribute transmission can be achieved within the same object domain without using any external technology, such as XML. The invention demonstrates a way of transmitting a data object by ripping it of its behaviors without dealing with the complexity of the data object.

Prior art methods typically require the creation of a common structure to achieve platform-independent data transfer architecture, but do not teach that the data object behaviors need not be an integral part of the data object. In contrast, the present invention addresses the aspect of reducing the numbers of data object classes on the client side. For certain classes, according to the present invention, it is possible to segregate data and behavior successfully without the loss of data content.

Moreover, other prior art methods require the translation of a data object into another format for handling. For example, db2 data may be translated into another heterogeneous system format, such as C++, and then mapped back into AS400 in order to address the data incompatibility issues of a different system. In contrast, in the present invention, we do not move from one system to another. Instead, there is scope for minimizing redundancy within a homogeneous client server system that can be achieved by using a proxy object or similar data mapping approach. Moreover, the present invention can achieve a common in-between pass for operating between heterogeneous environments.

Prior art methods also require prior knowledge of data object complexity for property mapping or conversion operations. Another advantage of the present invention is that a proxy generic data object is generated from a data object on the fly, without requiring prior knowledge of data object complexity, as will be apparent to one skilled in the art from the embodiments described herein.

Referring now to Table 1, a Java software interface “DataObjectInterface” according to the present invention is illustrated suitable to act as a proxy for all DataObjects.

TABLE 1

| | |
|---|---|
| 1.1. | public interface DataObjectInterface { |
| 1.2. | public abstract Object callGetter(String methodName); |
| 1.3. | public abstract boolean callSetter(String methodName, |

Object obj_val);

| | |
|---|---|
| 1.4. | public abstract Object getMemberVal(String p_MemberName); |
| 1.5. | public abstract boolean setMemberVal(String p_MemberName, |

Object obj_val);

1.6.

| | |
|---|---|
| 1.7. | public abstract void setDOName(String p_string); |
| 1.8. | public abstract String getDOName( ); |
| 1.9. | public abstract Object retriveDO( ); |
| 1.10. | public abstract void retriveDO(Object targetDO); |
| 1.11. | } |

The software code provided in Table 1 maps the data attributes of a data object to a generic data object according to the present invention. Thus, specifically, attribute “getting” functions and “setting” functions are provided by the instructions listed in Table 1, as will be readily apparent to one skilled in the art of Java programming. More particularly, Table 1, lines 1.2 and 1.3, provide for attribute “getting” functions (wherein the “String methodName” attribute is provided to a caller) and “setting” functions. Table 1, lines 1.4 and 1.5, provide for member value attribute “getting” functions and “setting” functions. Table 1, lines 1.7 and 1.8, provide for DataObject name attribute “getting” functions and “setting” functions. And, lastly, the retrieval of the DataObject encoded in the GenericDataObject instance, where the GenericDataObject is sent to the server created by the client, DataObject retrieval from the target server (or client side) is accomplished through Table 1, lines 1.9 and 1.10.

Table 2 is a generic implementation of the DataObjectinterface illustrated in Table 1, providing a proxy object capable of holding the properties of the DataObject in a “GenericDataObject” class.

TABLE 2

| | |
|---|---|
| 2.1. | public class GenericDataObject implements DataObjectInterface |
| 2.2. | { |
| 2.3. | public static GenericDataObject ConvertToGenericDataObject |
| | (Object sourceDataObject) |
| 2.4. | public static Object retrieveDO(Object sourceDataObject) |
| 2.5. | } |

The GenericDataObject implements the DataObjectInterface and provides a static method capable of converting a normal DataObject instance to a GenericDataObject instance. The present embodiment of the invention internally uses a Hash table to hold object properties, although it will be readily apparent to one skilled in the art that other structures may be used, such as an encoded byte array or an encoded string.

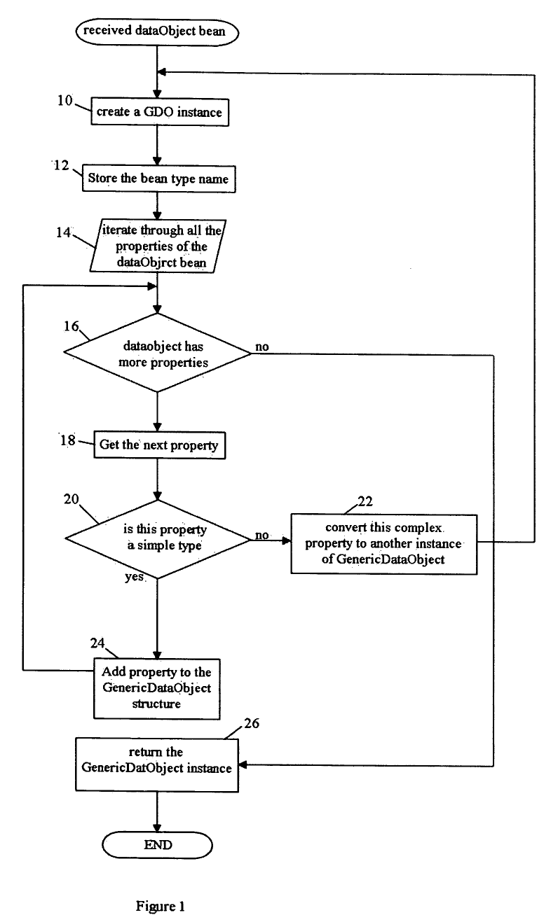

FIG. 1 is a block diagram illustrating a conversion of instance of data object to GenericDataObject according to the present invention. When a DataObject bean is received, the process initiates in step 10 to create a GenericDataObject instance. Step 12 associates the DataObject class name with the GenericDataObject instance. Step 14 iterates through all the properties of the DataObject. In step 16, it is determined whether the DataObject has any more properties left; if not, then the resultant GenericDataObject instance is returned for transmission to the client in step 26. Else, step 18 retrieves the next property of the DataObject bean. Step 20 checks if the property is a simple type. The property would be considered a simple type when the class type would be available on the client side and may be easily handled and recognized by the client, wherein no conversion is indicated, and the property is stored in the GenericDataObject instance step 24 and the process loops back to step 16 to determine any further properties. However, if the property type is complex, then, according to the present invention in step 22, the property is passed back to step 10 for converting to another GenericDataObject instance. The process loop continues until no more properties remain, wherein, the resultant GenericDataObject instance is returned for transmission to the client in step 26.

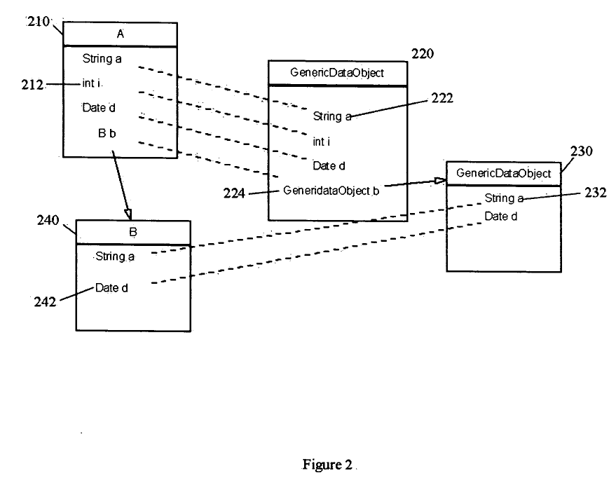

FIG. 2 is a block diagram illustrating step data element mapping from a DataObject class instance to a GenericDataObject instance according to the present invention. DataObject A 210 comprises simple data instances string a, integer i and Date d 212 and complex instance b of class B 240. The simple instances 212 may be handled easily by the target server or client without conversion and, accordingly, they are mapped directly to the GenericDataObject 220. However, the complex data instance B 240 must be converted according to the present invention, and the complex instances string b and date d 242 are mapped to a new GenericDataObject 230 as GenericDataObject instances 232. GenericDataObject 220 instance d 224, in turn, points to the GenericDataObject 230 as replacement for the complex DataObject instances 242. Thus, GenericDataObjects 220 with 230 are forwarded to the target client for handling as proxy objects for the DataObject 210 and 240.

A “generic data object” Java software embodiment appropriate for implementation according to the instructions listed in Table 1 and Table 2 above is now provided below. Each of the software code lines below are to be understood as following sequentially from each other in a typical implementation, as will be readily understood by one skilled in object-oriented programming in Java.

Initially, standard Java packages are imported:

import java.io.Serializable;
import java.util.Hashtable;
import java.lang.reflect.Method;

Next, standard Java-class interfaces are implemented according to the “public class GenericDataObject” instruction of Table 1. According to the present invention, a custom class is provided to replace original null values found in the original data object:

public class GenericDataObject implements Serializable,
DataObjectInterface
{

/**
* NullObject class is privately defined to be internally

used for a member variable with null value.

*/
static class NullObj implements Serializable
{

public String toString( )
{

return (“[null]”);

}

}

Next, the class name associated with the original data object as determined by Table 1, lines 1.7 and 1.8, is stored. The hash table is used to store all the data members of the data object; and where a GenericDataObject must be created, the “class GenericDataObject” command will provide naming and name passing functions:

protected String m_DOName;
protected Hashtable m_members;
private GenericDataObject( )
{

m_members = new Hashtable( );

}
public GenericDataObject(String p_DOName)
{

m_members = new Hashtable( );
m_DOName = p_DOName;

}

Next, a conversion from an original data object to a GenericDataObject is provided. Original data object parameters are received by call functions. The name of the original data object type name is obtained by a “getClass( ).getName( )” function from the original data object class, and the new GenericDataObject instance is built from the original data object classes. A loop is provided to retrieve one-by-one all of the original data object properties using all the available getter methods of the data object. Absence of values and presence of a “null” in the original data object are distinguished through a “mem_value==null” query:

public static GenericDataObject ConvertToGenericDataObject(Object

fromObject)

{

GenericDataObject gdo = null;
try
{

Class fromObjectClass = fromObject.getClass( );
String doclass_name = fromObjectClass.getName( );
gdo = new GenericDataObject(doclass_name);
Method[] methods =

fromObjectClass.getDeclaredMethods( );

for (int i = 0; i < methods.length; i++)
{

Method obj_meth = methods[i];
String met_name = null;
if (obj_meth == null)

continue;

met_name = obj_meth.getName( );
if (met_name.startsWith(“get”))
{

String mem_name =
met_name.substring(3);
Object mem_value =

obj_meth.invoke(fromObject, null);

if (mem_value == null)
{

gdo.m_members.put(mem_name,
new

NullObj( ));

}
else
{

| // Check if the member value object is of simple type, it can be | |
|---|---|
| //considered a simple type if the class is available on the | |
| //clientplatform, and can be loaded by the client classloader. | |
| //else create another GenericDataObject instance and then put | |
| // | if (mem val of primary type) |
| // | { |

gdo.m_members.put(mem_name, mem_value);

| // | } |
|---|---|
| // | else |
| // | { |
| // m_members.put(mem_name, new | |
| GenericDataObject(mem_value)); | |
| // | } |

}

}

}

}

Next, a “catch” function is provided to identify any errors that may have occurred in the previous software blocks by printing an error message. After this last function, a GenericDataObject is ready to be returned by the “return gdo” command as proxy for the original Data Object:

catch (Exception e)
{

System.err.println(

“[UDO:ERROR] ” + “Exception in Constructing to

GenericDataObject\n” + e);

e.printStackTrace( );

}
return gdo;

}

Next, on the client side, the GenericDataObject will be created first, and then its members populated, prior to passing the GenericDataObject back to the server. Thus, according to the present invention, routines are now provided to create an instance of the GenericDataObject. For member extraction, the “callGetter” functions are thus provided subsequently. Error display functions are also provided:

public GenericDataObject createGDOforClass(String p_DOClassName)
{

return new GenericDataObject(p_DOClassName);

}
public Object callGetter(String methodName)
{

if (methodName.startsWith(“get”))
{

return getMemberVal(methodName.substring(3));

}
else
{

System.err.println(

“[UDO:ERROR] ”

+ “Setter Method ”
+ methodName
+ “ syntex name correct eg. getMemName”);

return null;

}

}

Next, member-setting functions are provided, including error functions:

public boolean callSetter(String methodName, Object obj_val)
{

if (methodName.startsWith(“set”))
{

return setMemberVal(methodName.substring(3),

obj_val);

}
else
{

System.err.println(

“[UDO:ERROR] ”

+ “Setter Method ”
+ methodName
+ “ syntex name correct eg. setMemName”);

}
return false;

}

Next, “public Object retriveDataObject” and “public void retriveDataObjectBean” functions according to Table 1, lines 1.9 and 1.10, are provided. Where a GenericDataObject has been created, then it may be retrieved by creating an instance and repopulating it from the original GenericDataObject. The “public void retriveDataObject” function enables repopulating of the original data object with values from the GenericDataObject:

public Object retriveDataObject( )
{

Object targetObject = null;
try
{

Class targetObjectClass;
try
{

targetObjectClass =

Class.forName(this.getDOName( ));

}
catch (ClassNotFoundException cnfe)
{

System.err.println(

“[UDO:HANDLED_ERROR] ”

+ “DO Name is not a local Class

Name. Do not know what type of object to return\n”);

return null;

}
retriveDO((targetObjectClass.newInstance( )));

}
catch (Exception e)
{

System.err.println(

“[UDO:UNEXPECTED_ERROR] ” + “Exception

retrieving from GenericDataObject\n”);

e.printStackTrace( );

}
return targetObject;

}
public void retriveDO(Object targetObject)
{

//Throws Null pointer Exception if parameter Object is
null
try
{

if (targetObject == null)
{

System.out.println(“[UDO:HANDLED_ERROR]” +

“Unexpected null parameter”);

return;

}
Class targetObjectClass = targetObject.getClass( );

Method[] methods =

targetObjectClass.getDeclaredMethods( );

for (int i = 0; i < methods.length;

i++)

{

Method obj_meth = methods[i];
String met_name = null;
if (obj_meth == null)

continue;

met_name =

obj_meth.getName( );

if

(met_name.startsWith(“set”))

{

String mem_name =

met_name.substring(3);

Object mem_DO_value =

m_members.get(mem_name);

if (mem_DO_value !=

null)

{

if (mem_DO_value

instanceof NullObj)

{

obj_meth.invoke(targetObject, new Object[] { null });

}
else
{

obj_meth.invoke(targetObject, new Object[] {
mem_DO_value });

}

}
else
{

System.err.println(
“[UDO:HANDLED_ERROR] ”

+

“Member ” + mem_name + “is not set. returning null”);

}

}

}

}
catch (Exception e)
{

System.err.println(

“[UDO:UNEXPECTED_ERROR] ” + “Exception

retrieving from GenericDataObject\n”);

e.printStackTrace( );

}

}

Next, “public String getDOName” functions according to Table 1, lines 1.7 and 1.8, are provided, wherein the original data object name is returned, and the hash table memory block used to store the associated member:

public String getDOName( )
{

return m_DOName;

}
public Hashtable getMemberHash( )
{

return m_members;

}
public Object getMemberVal(String p_MemberName)
{

Object out_obj = m_members.get(p_MemberName);
if (out_obj == null)
{

System.err.println(

“[UDO:HANDLED_ERROR] ” + “Member ” +

p_MemberName + “ does not exits”);

return null;

}
else if (out_obj instanceof NullObj)
{

return null;

}
else
{

return out_obj;

}

}

Next, “public void setDOName” and “public boolean setMemberVal” functions according to Table 1, lines 1.7 and 1.8, are provided, wherein the original data object name is set externally:

public void setDOName(String p_string)
{

m_DOName = p_string;

}
public boolean setMemberVal(String p_MemberName, Object
obj_val)
{

if (obj_val == null)
{

m_members.put(p_MemberName, new NullObj( ));

}
else
{

m_members.put(p_MemberName, obj_val);

}
return false;

}

}

It is common for computer systems to require validation of data at the server side of an object transmission. Accordingly, it will be readily apparent to one skilled in the art that the present invention may be extended to provide validation of the data object to member mapping functions.

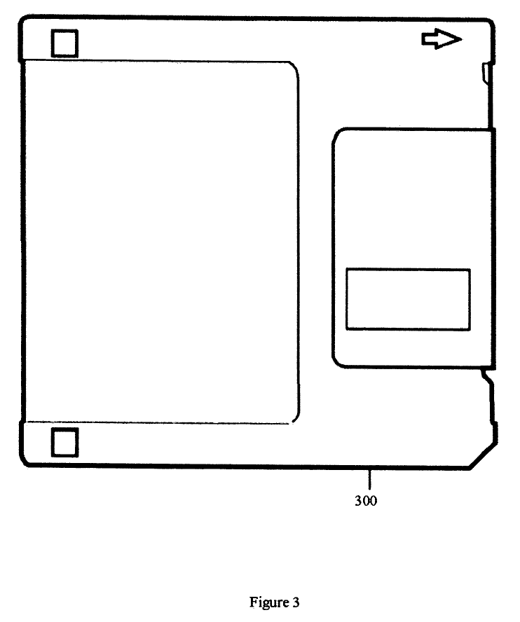

FIG. 3 shows an embodiment of the invention described above tangibly embodied in a computer program residing on a computer-readable medium or carrier 300. Other appropriate machine readable storage mediums include fixed hard drives, optical discs, magnetic tapes, semiconductor memories, such as read-only memories (ROMs), programmable (PROMs), etc. The medium 300 containing the computer readable code is utilized by executing the code directly from the storage device, or by copying the code from one storage device to another storage device, or by transmitting the code on a network for remote execution. The medium 300 may comprise one or more of a fixed and/or removable data storage device, such as a floppy disk or a CD-ROM, or it may consist of some other type of data storage or data communications device. The computer program comprises instructions which, when read and executed by a computer processor, causes the processor to perform the steps necessary to execute the steps or elements of data object mapping and/or conversion to generic data objects according to the present invention.

It is to be understood that, while preferred embodiments of the invention have been described herein, variations in the design may be made, and such variations may be apparent to those skilled in the art of computer programming and object-oriented design in general, as well as to those skilled in other arts. The exemplary methods and system embodiments identified above are by no means the only materials suitable for practicing the invention. Substitute method steps and system implementations will be readily apparent to one skilled in the art. The scope of the invention, therefore, is only to be limited by the following claims.

What is claimed is:

1. A method for processing data objects, comprising the steps of:
providing a server-defined generic data object structure having a generic data object class;
mapping an original data object having at least one data property and at least one data object class to the generic data object;
the generic data object class serving as a proxy for each of the at least one data object classes; and
handling the generic data object as a proxy for the data object at a server or client side of a network processor transaction.

2. The method of claim 1, wherein the at least one data object class comprises a first data object class and a second data object class, and the step of the generic data object class serving as a proxy for each of the at least one data object classes further comprises the steps of:
the generic data object class serving as a proxy for the first data object class; and
the generic data object class serving as a proxy for the second data object class.

3. The method of claim 2, wherein the first data object class and the second data object class are not preset on the client side.

4. The method of claim 1, wherein the original Data Object data properties comprise a simple data instance having a simple data object class and a complex data instance having a complex data instance class, the step of mapping the Data Object data instance further comprising the steps of:
mapping the simple data instance to a first Generic Data Object, the generic data object class serving as proxy for the simple data object class;
converting the complex data instance to a second Generic Data Object; and
mapping the second Generic Data Object to the first GenericDataObject, the generic data object class serving as proxy for the complex data object class.

5. The method of claim 4, further comprising the step of reducing a number of data classes coupling from the client to the server.

6. The method of claim 1, further comprising the step of building a Generic Data Object instance from the at least one data object class.

7. The method of claim 6, wherein the step of building a Generic Data Object instance further comprises the steps of:
a client side creating the Generic Data Object;
populating a plurality of Generic Data Object members; and
the client side passing the Generic Data Object back to the server.

8. The method of claim 1, further comprising the steps of:
repopulating the original data object with values from the Generic Data Object; and
retrieving the original data object.

9. The method of claim 1, further comprising the step of revising an original class of the at least one data object class to produce a revised data object class, wherein the step of handling the generic data object as a proxy for the data object at a server or client side of a network processor transaction does not require transmitting the revised data object class to the client.

10. A network processor computer system to define and handle a data object as a proxy generic object, wherein the computer system is configured to:
provide a server-defined generic data object structure having a generic data object class;
map an original data object having at least one data property and at least one data object class to the generic data object, the generic data object class serving as a proxy for each of the at least one data object classes; and
handle the generic data object as a proxy for the data object at a server or client side of a network processor transaction.

11. The system of claim 10, wherein the at least one data object class comprises a first data object class and a second data object class, the generic data object class serving as a proxy for the first data object class, and the generic data object class serving as a proxy for the second data object class.

12. The system of claim 10, wherein the first data object class and the second data object class are not preset on the client side.

13. The system of claim 10, wherein the original Data Object data properties comprise a simple data instance having a simple data object class and a complex data instance having a complex data instance class, the system further configured to:
map the simple data instance to a first Generic Data Object, the generic data object class serving as proxy for the simple data object class;
convert the complex data instance to a second Generic Data Object; and
map the second Generic Data Object to the first Generic Data Object, the generic data object class serving as proxy for the complex data object class.

14. The system of claim 13 further configured to reduce a number of data classes coupling from the client to the server.

15. The system of claim 10 further configured to build a Generic Data Object instance from the at least one data object class.

16. The system of claim 15, wherein the computer system is further configured to populate a plurality of Generic Data Object members; and
the client side is configured to create the Generic Data Object and pass the Generic Data Object back to the server.

17. The system of claim 10, wherein the computer system is further configured to repopulate the original data object with values from the Generic Data Object, and retrieve the original data object.

18. The system of claim 10, wherein the computer system is further configured to handle the generic data object as a proxy for the data object at a server or client side of a network processor transaction without requiring transmission of a revised data object class to the client when an original class of the at least one data object class is revised to produce a revised data object class.

19. An article of manufacture comprising a computer usable medium having a computer readable program embodied in said medium, wherein the computer readable program, when executed on a computer, causes the computer to:
provide a server-defined generic data object structure having a generic data object class;
map an original data object having at least one data property and at least one data object class to the generic data object, the generic data object class serving as a proxy for each of the at least one data object classes; and
handle the generic data object as a proxy for the data object at a server or client side of a network processor transaction.

20. The article of manufacture of claim 19, wherein the at least one data object class comprises a first data object class and a second data object class, and the computer readable program, when executed on a computer, further causes:
the generic data object class to serve as a proxy for the first data object class; and
the generic data object class to serve as a proxy for the second data object class.
